(19) United States
(12) Patent Application Publication
(10) Pub. No.: US 2026/0141175 A1
(43) Pub. Date: May 21, 2026

(54) THE WORD OF GOD (WOG): THE 1,197,000 LETTER STRING OF ENCODED HEBREW LETTERS UNDERLYING THE ORIGINAL BIBLE

(71) Applicant: Don Karl Juravin, San Antonio, FL (US)

(72) Inventor: Don Karl Juravin, San Antonio, FL (US)

(21) Appl. No.: 19/446,170

(22) Filed: Jan. 12, 2026

Related U.S. Application Data
(63) Continuation-in-part of application No. 18/092,272, filed on Dec. 31, 2022, now abandoned.
(63) Continuation-in-part of application No. 19/308,719, filed on Aug. 25, 2025.
(60) Provisional application No. 63/928,815, filed on Dec. 1, 2025.

(51) Int. Cl. G06F 40/284; G06F 40/30

(52) U.S. Cl. CPC G06F 40/284; G06F 40/30

(57) ABSTRACT

A data structure and associated methods for analysis of a continuous 1,197,000-letter unvocalized Hebrew string referred to as the Word of God (WOG). The data structure contains only the twenty-two classical Hebrew letters and their five final forms, with no spacing, punctuation, vowelization, or editorial symbols. Intrinsic placement of the final letters enables deterministic segmentation of the string into 305,490 lexical units and 23,206 verses without external conventions. Fixed letter-number assignments provide a numeric architecture for evaluating substrings, detecting alterations, identifying encoded mathematical correspondences, and performing pattern analysis. The system preserves full semantic range by supporting multiple morphologically valid interpretations of unvocalized Hebrew strings. Methods for segmentation, numeric evaluation, reconstruction, integrity verification, semantic analysis, and mathematical pattern detection are provided thereby providing a reproducible foundation for computational and linguistic research.

### PRIOR HISTORY

This application claims the benefit of U.S. Provisional Patent Application No. 63/928,815 filed in the United States Patent and Trademark Office (USPTO) on 1 Dec. 2025; is a Continuation-in-Part Patent Application of U.S. patent application Ser. No. 19/308,719 filed in the USPTO on 25 Aug. 2025; and is a Continuation-in-Part Patent Application of U.S. patent application Ser. No. 18/092,272 filed in the USPTO on 31 Dec. 2022, the specifications and figures of which applications are hereby incorporated by reference.

### FIELD OF THE PRESENTLY DISCLOSED SUBJECT MATTER

The presently disclosed subject matter relates to the structure and properties of a continuous Hebrew text string consisting of 1,197,000 letters, referred to as the Word of God (WOG). The Word of God (WOG): A 1,197,000-Letter Encoded Hebrew String Serving as the Foundational Linguistic, Structural, and Numeric Data Architecture for Textual Reconstruction and Computational Analysis.

### BACKGROUND OF THE PRESENTLY DISCLOSED SUBJECT MATTER

Existing Hebrew textual traditions—including the Masoretic Text, printed Tanach editions, and classical manuscript families-contain post-origin editorial additions such as:
spacing inserted by scribes,
vowel markings (Nikud) introduced in the early Middle Ages,
punctuation,
cantillation marks, and
orthographic conventions reflecting later interpretive frameworks.

These additions alter the original letter string, disrupt internal structural relationships, and obscure inherent linguistic and numeric properties of the ancient text. Because spacing and vowelization were introduced centuries after the earliest textual layers, no existing printed or manuscript tradition preserves the unaltered, continuous Hebrew letter stream from which all later versions derive.

The absence of such a source has created persistent limitations in:
reconstructing the original structure of the text,
identifying authentic word boundaries,
conducting computational linguistic analysis,
performing numeric validation of letter strings,
extracting encoded linguistic or mathematical patterns, and
verifying manuscript integrity across traditions.

The presently disclosed subject matter addresses these limitations by disclosing a 1,197,000-letter continuous Hebrew string (the Word of God, WOG) that contains no spaces, punctuation, or vowel marks; preserves the original, uninterrupted letter order; incorporates the five final Hebrew letters ( [symbol] , [symbol] , [symbol] , [symbol] , [symbol] ) as intrinsic structural markers, supports deterministic segmentation into 305,490 words and 23,206 verses using only internal rules; enables reproducible reconstruction of a complete ancient Hebrew text without reliance on later editorial systems; and provides a stable data architecture suitable for linguistic analysis, numeric evaluation, and computational research. Because the WOG preserves the original structure of the Hebrew textual system without later modifications, it represents a superior foundational source for textual reconstruction, algorithmic segmentation, and computational study compared to any extant manuscript or printed edition.

### GENERAL DESCRIPTIONS AMD SUMMARY

The presently disclosed subject matter discloses a continuous 1,197,000-letter Hebrew text string, referred to as the Word of God (WOG), which functions as a self-contained linguistic, structural, and numeric data architecture. The WOG contains no spaces, punctuation, vowel markings (Nikud), cantillation marks, or other post-origin editorial additions. Its structure is based solely on the twenty-two classical Hebrew letters together with their five final forms ( [symbol] , [symbol] , [symbol] , [symbol] , [symbol] ). The presently disclosed subject matter concerns the fields of: computational linguistics, structural language analysis, textual encoding systems, data architecture, manuscript reconstruction, information theory, and algorithmic segmentation of unspaced text.

More specifically, the presently disclosed subject matter discloses an encoded Hebrew letter string that functions as the foundational linguistic, structural, and numeric data architecture from which a deterministic 305,490-word, 23,206-verse textual output (the “Original Bible”) can be reconstructed using internal structural rules without reliance on external editorial conventions such as spacing, punctuation, or vowel markings (Nikud).

The presently disclosed subject matter provides methods and systems for:
1. Segmenting the WOG string into discrete lexical units using the intrinsic placement of final letters as structural boundary markers;
2. Reconstructing a deterministic 305,490-word, 23,206-verse text (“Original Bible”) exclusively from the WOG without reliance on later editorial conventions;
3. Applying letter-value encodings (as defined in U.S. Pat. No. 12,400,087) to extract internal numeric patterns from the WOG, enabling computational validation and structural analysis;
4. Performing semantic decomposition of unvocalized Hebrew substrings to derive multi-layered linguistic meaning consistent with the architecture of the WOG;
5. Verifying textual integrity using numeric checksums, positional analysis, and structural pattern detection;
6. Identifying encoded mathematical structures, including numeric strings corresponding to segments of the mathematical constant Pi (x), which emerge from the WOG's letter-value architecture; and
7. Representing the WOG as a computationally analyzable matrix suitable for linguistic research, information-theoretic study, and algorithmic processing.

The WOG thus provides a unique, internally regulated textual system capable of producing a reproducible segmented output, supporting numeric validation, and enabling computational extraction of linguistic and mathematical properties. All subsequent data, segmentation, and reconstructed text arise solely from the intrinsic rules encoded within the 1,197,000-letter string.

There is provided in accordance with a first aspect according to the presently disclosed subject matter A data structure comprising: a continuous string of 1,197,000 Hebrew letters arranged without spacing, punctuation, vowel markings (Nikud), cantillation marks, or post-origin editorial symbols, wherein the string includes the twenty-two classical Hebrew letters and their five final forms ( [symbol] , [symbol] , [symbol] , [symbol] , [symbol] ), and wherein the uninterrupted arrangement of said letters defines: (a) an intrinsic segmentation system based solely on the positional occurrence of the five final Hebrew letters, (b) an intrinsic numeric architecture arising from fixed letter-number assignments, and (c) a reproducible structural basis for computational reconstruction, numeric evaluation, and pattern analysis.

According to a further aspect according to the presently disclosed subject matter there is a provided A method for segmenting the data structure into discrete lexical units, the method comprising the steps of (a) reading the continuous 1,197,000-letter string sequentially from its first letter to its last; (b) identifying positions within the string at which a letter appears in one of the five final Hebrew forms ( [symbol] , [symbol] , [symbol] , [symbol] , [symbol] ), each such position defining a candidate boundary between lexical units; (c) extracting, for each candidate boundary, the contiguous string of letters extending from the previous boundary to the current boundary; (d) validating each extracted string as a lexical unit by applying established Hebrew morphological patterns and distributional characteristics consistent with unvocalized Hebrew; and (e) generating a reproducible set of segmented lexical units, wherein the segmentation is determined solely by the intrinsic placement of the five final Hebrew letters within the data structure.

In some applications, a method for performing numeric evaluation on the data structure is provided, which method comprises the steps of (a) assigning to each Hebrew letter within the 1,197,000-letter string a fixed numeric value, the values being predetermined and consistent across all evaluations; (b) receiving as input any contiguous substring of the data structure; (c) computing a numeric value for the substring by summing the numeric values of its constituent letters in string order; and (d) generating, for each substring, a reproducible numeric output that is uniquely determined by the letters of the substring and the fixed letter-number assignments.

In some applications, a method for reconstructing a multi-unit Hebrew text from the data structure which comprises the steps of (a) applying the segmentation method to the continuous 1,197,000-letter string, thereby producing a reproducible set of lexical units based solely on the intrinsic placement of the five final Hebrew letters; (b) validating each lexical unit by confirming consistency with unvocalized Hebrew morphological patterns and distributional properties intrinsic to the data structure; (c) arranging the validated lexical units in string order to form a continuous multi-unit text; and (d) producing, by said arrangement, a deterministically repeatable text comprising 305,490 lexical units further organized into 23,206 verses, the structure of which is derived exclusively from the intrinsic properties of the data structure.

In some applications, a method for verifying textual integrity of the data structure is provided, whereby the method comprises the steps of (a) receiving as input the continuous 1,197,000-letter string or any portion thereof; (b) computing numeric values for one or more contiguous substrings in accordance with the numeric evaluation method; (c) detecting deviations in numeric values, substring distributions, or expected morphological patterns that result from any insertion, deletion, or substitution of letters within the string; (d) confirming segmentation stability by verifying that the positions of the five final Hebrew letters continue to produce the same reproducible set of lexical units obtained; and (e) identifying any alteration to the data structure when the numeric values, segmentation boundaries, or pattern distributions fail to match the values and boundaries produced by the unaltered data structure.

In some applications, a method for preserving the full semantic range of unvocalized Hebrew text using the data structure is provided, whereby the method comprises the steps of (a) providing the continuous 1,197,000-letter string in its unvocalized and unsegmented form; (b) receiving as input any contiguous substring corresponding to a Hebrew lexical string produced by the segmentation method; (c) interpreting said substring without reliance on externally imposed vowel markings, spacing conventions, or editorial symbols; (d) generating a set of alternative, morphologically valid readings of the substring in accordance with established Hebrew linguistic principles, including multiple legitimate root assignments, morphological decompositions, and semantic families; and (e) preserving, for each substring, all semantically valid interpretations that are supported by the original unvocalized letter string, wherein such interpretations would be restricted or eliminated in vowelized or pre-segmented Hebrew texts.

In some applications, a method for identifying encoded mathematical structures within the data structure is provided, whereby the method comprises the steps of (a) providing the continuous 1,197,000-letter string with fixed letter-number assignments; (b) receiving as input one or more contiguous substrings of the data structure; (c) computing numeric values for each substring by summing the numeric values of its constituent letters; (d) detecting numeric correspondences between the computed values of selected substrings and independently defined mathematical values, constants, or strings, including but not limited to digit-based summations of the mathematical constant Pi; and (e) identifying reproducible mathematical relationships arising solely from the intrinsic letter order and numeric architecture of the data structure, wherein said relationships are not dependent on external spacing, vowelization, or editorial modification.

In some applications, the method comprises the step of validating each extracted lexical unit further comprises confirming that the unit exhibits a numeric value consistent with the fixed letter-number assignments. In some applications, the method comprises the segmentation step produces exactly 305,490 lexical units derived solely from the positional occurrence of the five final Hebrew letters. In some applications, the segmentation boundaries remain unchanged across different computational platforms, thereby producing a reproducible output independent of operator input. In some applications, the 305,490 lexical units are further arranged into exactly 23,206 verses as determined exclusively by intrinsic positional and structural patterns within the data structure.

In some applications, the step of computing the numeric value of a substring further comprises the step of generating a distribution profile of numeric values across sequential substrings of the data structure. In some applications, the numeric value of each substring is stored in association with its positional index within the data structure to enable pattern tracking and anomaly detection. In some applications, detecting deviations comprises the step of comparing expected numeric value distributions to observed distributions to identify any irregularities caused by letter-level alterations. In some applications, identifying an alteration includes determining the precise location of the insertion, deletion, or substitution within the 1,197,000-letter string. In some applications, generating alternative morphologically valid readings includes identifying multiple legitimate root assignments for each substring.

In some applications, preserving semantic interpretations comprises storing all valid morphological decompositions for later computational or linguistic analysis. In some applications, detecting numeric correspondences further comprises the step of identifying structural ratios within the letter string that approximate mathematical constants. In some applications, the mathematical correspondence includes a substring whose computed numeric value equals 2701, matching the sum of a defined quantity of digits of the mathematical constant Pi. In some applications, any alteration of a letter within the 1,197,000-letter string results in detectable numeric or structural deviation under other methodologies.

According to another aspect of the presently disclosed subject matter, there is provided a method for universally authenticating an original biblical text, comprising the steps of (a) providing a continuous string of 1,197,000 encoded Hebrew letters, wherein said string lacks spacing, punctuation, vowelization, chapters, verses, or editorial annotations, and wherein the order of letters is fixed and invariant; (b) deriving a structured biblical text from said string solely by inserting spaces to delineate discrete lexical units while preserving the exact letter order of the string; (c) grouping said lexical units into verses and higher textual groupings based on linguistic continuity and connective letter usage, without altering, adding, deleting, or rearranging any letter of the string: (d) optionally applying vowel markings or pronunciation indicators as a non-original annotation layer subsequent to derivation of the structured text; (e) comparing any text claiming to be a biblical text against the continuous string to determine whether the claimed text is fully derivable from said string without modification of letter identity or order; wherein a text is authenticated as a text claimed to represent an original biblical corpus only if it is derivable from the continuous string by spacing and structural grouping alone, and wherein any text not so derivable is determined not to be a text claimed to represent an original biblical corpus.

### BRIEF DESCRIPTION OF THE DRAWINGS

FIG. 1 illustrates the first 1,802 letters of the 1,197,000-letter Word of God (WOG) string, presented in continuous unvocalized Hebrew script.

FIG. 2 firstly illustrates the five final Hebrew letters ( [symbol] , [symbol] , [symbol] , [symbol] , [symbol] ) and their corresponding standard forms and is presented in side-by-side relation to FIG. 2A for ease of reference.

FIG. 2A is a continuous letter string showing the final five Hebrew letters otherwise shown in FIG. 2 as inserted into the continuous letter string as intrinsic structural components of the WOG functioning as boundary markers enabling segmentation of the continuous string into valid lexical units.

FIG. 3 secondly illustrates the five final Hebrew letters ( [symbol] , [symbol] , [symbol] , [symbol] , [symbol] ) and their corresponding standard forms and is presented in side-by-side relation to FIG. 2A for ease of reference.

FIG. 3A presents an example segmentation diagram showing how the WOG string is divided into discrete Hebrew words using the intrinsic placement of the final Hebrew letters.

FIG. 4 is an exemplary opening stanza from the first 1,802 letters of the 1,197,000-letter WOG juxtapositioned adjacent a structural matrix representation of the WOG, including positional indexing, letter-frequency distribution, and numeric-value mapping based on the letter-number assignments defined in U.S. Pat. No. 12,400,087 and corresponding to the first 1,802 letters of the 1,197,000-letter WOG.

FIG. 4A presents a structural matrix representation of the WOG, including positional indexing, letter-frequency distribution, and numeric-value mapping based on the letter-number assignments defined in U.S. Pat. No. 12,400,087 and corresponding to the first 1,802 letters of the 1,197,000-letter WOG.

FIG. 5 is a screenshot of the graphical user interface of the code2GOD divine decoder tool according to the presently disclosed subject matter after the user has input an exemplary Hebrew word for analysis extracted from the WOG which correspond to early digits of the mathematical constant Pi (π).

### DETAILED DESCRIPTION OF THE EMBODIMENTS

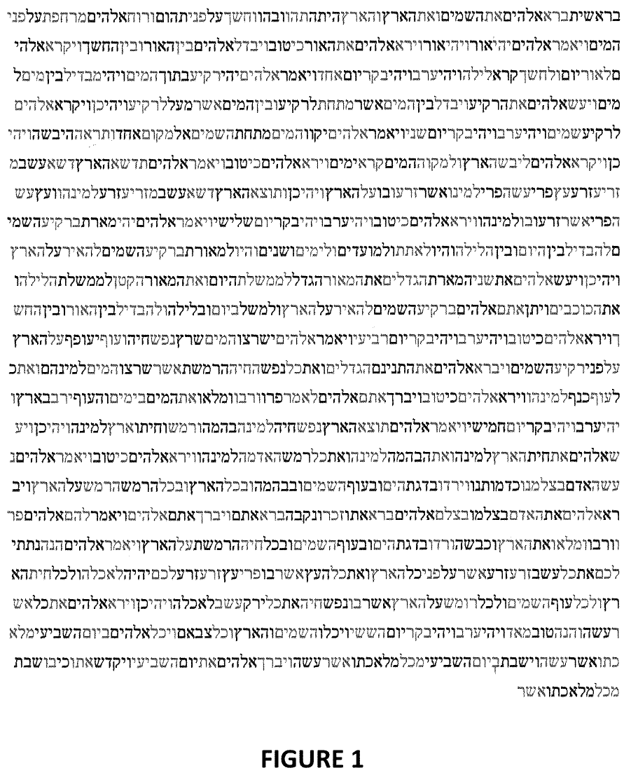

Referring now to the drawings with more specificity, FIG. 1 illustrates the first 1,802 letters of the 1,197,000-letter Word of God (WOG) string, presented in continuous unvocalized Hebrew script. This figure demonstrates the structural properties of the WOG as an uninterrupted letter string without spaces, punctuation, vowel markings (Nikud), or editorial additions. This disclosure pertains to the initial 1,802 letters of the complete 1,197,000-letter Hebrew sequence composing the WOG string. For clarity of illustration, every alternate word has been highlighted in grayscale to facilitate identification and distinction within the continuous Hebrew text.

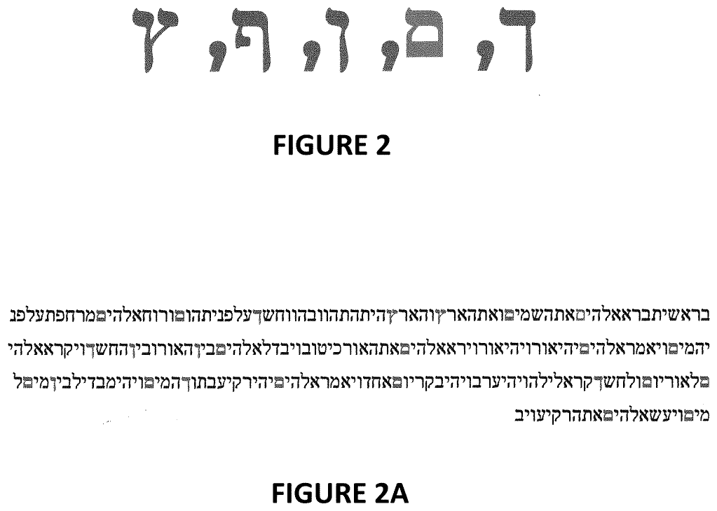

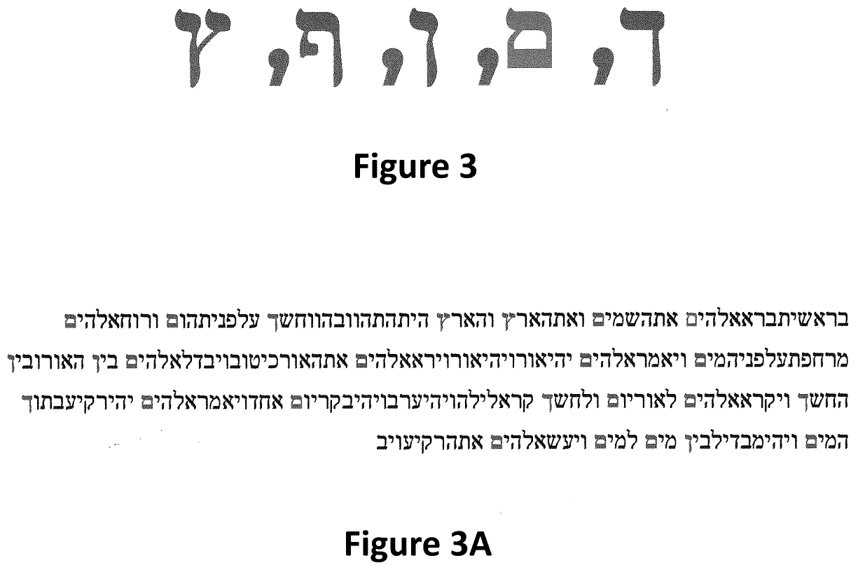

FIG. 2 firstly illustrates the five final Hebrew letters ( [symbol] , [symbol] , [symbol] , [symbol] , [symbol] ) and their corresponding standard forms juxtaposed adjacent FIG. 2A for ease of reference. These letters are intrinsic structural components of the WOG and function as boundary markers enabling segmentation of the continuous string into valid lexical units as further depicted in FIG. 2A. FIG. 3 secondly illustrates the five final Hebrew letters ( [symbol] , [symbol] , [symbol] , [symbol] , [symbol] ) and their corresponding standard forms juxtaposed adjacent FIG. 3A for ease of reference. FIG. 3A presents an example segmentation diagram showing how the WOG string is divided into discrete Hebrew words using the intrinsic placement of the final letters. The diagram demonstrates how contiguous segments are identified and validated to reconstruct the 305,490-word, 23,206-verse textual output.

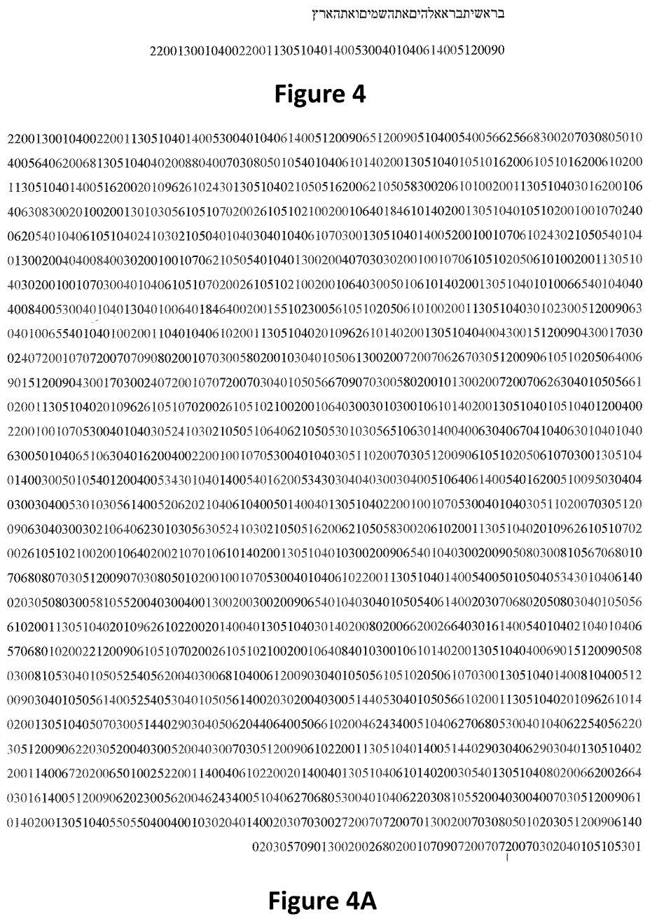

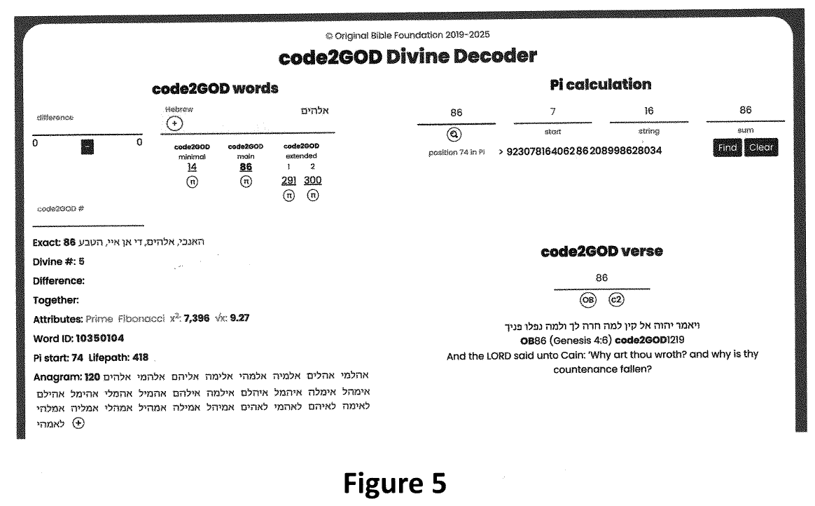

FIGS. 4 and 4A present a structural matrix representation of the WOG, including positional indexing, letter-frequency distribution, and numeric-value mapping based on the letter-number assignments defined in U.S. Pat. No. 12,400,087 B2. This matrix embodiment illustrates how the WOG operates as a computational data architecture. FIG. 5 is a screenshot of the graphical user interface of the code2GOD divine decoder tool according to the presently disclosed subject matter after the user has input an exemplary Hebrew word for analysis extracted from the WOG which correspond to early digits of the mathematical constant Pi (z). This figure demonstrates encoded mathematical structures arising from letter-value computations within the WOG.

### Overview of the WOG Structure

The presently disclosed subject matter discloses a continuous 1,197,000-letter Hebrew text string, referred to as the Word of God (WOG). The WOG is presented as an uninterrupted string of letters without punctuation, spacing, vowel markings (Nikud), cantillation marks, or any post-origin editorial additions. It uses only the twenty-two classical Hebrew letters and their five final forms. FIG. 1 illustrates the first 1,802 letters of the WOG, demonstrating the form of the unsegmented text and the structural characteristics of the letter stream. The complete WOG serves as the foundational linguistic and numeric dataset from which segmentation, computational analysis, and reconstruction of the 305,490-word, 23,206-verse text are performed.

### Letter-Number Encoding System

Each Hebrew letter in the WOG is assigned a fixed numeric value from 1 to 400, consistent with the letter-number mapping defined in U.S. Pat. No. 12,400,087. For any letter string “s” consisting of letters l₁, l₂, . . . , lₙ, the encoded numeric value W(s) is defined as:

$$W ( s ) = V ( {l}_{1} ) + V ( {l}_{2} ) + … + V ( {l}_{n} )$$

where V(lₖ) is the numeric value assigned to the letter lₖ.

This numeric architecture enables the WOG to function simultaneously as a linguistic string, a structured numeric dataset, a basis for computational pattern detection, a mechanism for validating segmentation, and a platform for extracting mathematical relationships.

### Intrinsic Segmentation Using the Five Final Letters

The Word of God (WOG) is an uninterrupted 1,197,000-letter Hebrew string containing no spacing, punctuation, or vowel markings. Segmentation of this continuous stream into discrete lexical units is achieved using a structural feature inherent to the Hebrew alphabet: the presence of five final letters that occur only at the end of words.

The five final letters are:
[symbol] (final Kaf)
[symbol] (final Mem)
[symbol] (final Nun)
[symbol] (final Peh)
[symbol] (final Tzadi)

These letters never appear at the beginning or middle of a lexical unit within the reconstructed output. Their presence in the WOG therefore functions as an intrinsic word-boundary indicator.

### Segmentation Method

The segmentation process proceeds as follows:
1. Read the WOG string sequentially from the first letter to the last.
2. When a final letter is encountered, treat that position as a candidate boundary.
3. Extract the letter string between the previous boundary and the current final letter.
4. Validate the extracted string using:
   known Hebrew morphological patterns (triliteral, biliteral, extended forms),
   frequency-based distribution rules derived from the WOG, and
   numeric consistency using the code2GOD letter-value system.
5. Confirm the segment as a lexical unit.
6. Move to the next letter and continue until the full string is processed.

Using this method, the WOG deterministically yields 305,490 words arranged into 23,206 verses, producing the complete reconstructed Hebrew text.

### Example

The following portion of the WOG:

[symbol]

results in the segmentation:

[symbol]

This example illustrates the segmentation principle but does not limit the scope of the presently disclosed subject matter.

### Advantages of Final-Letter Segmentation

This intrinsic segmentation system provides:
Reproducibility—any correct application of the method yields the same 305,490-word result.
Independence from later editorial conventions—no reliance on Masoretic spacing, punctuation, or Nikud.
No interpretive bias—boundaries arise solely from the original letter structure.
Numeric coherence—the segments align with letter-value patterns, enabling computational validation.
Textual integrity—the WOG itself dictates the structure of the reconstructed output without human alteration.

### Reconstruction of the 305,490-Word, 23,206-Verse Text

The 1,197,000-letter Word of God (WOG) contains all structural information necessary to generate a complete Hebrew text consisting of 305,490 words arranged into 23,206 verses. Reconstruction of this text is achieved solely through intrinsic features of the WOG and does not rely on external editorial traditions, including spacing, punctuation, vowel markings (Nikud), or interpretive conventions.

### Reconstruction Procedure

1. Input
   Provide the full 1,197,000-letter WOG string as a continuous, unmodified string.
2. Boundary Identification
   Apply the segmentation process defined in Section 6.3, using the five final Hebrew letters as intrinsic indicators of word boundaries.
3. Lexical Extraction
   Each boundary produces a candidate lexical segment.
   The segment is validated using:
      Hebrew morphological and distributional patterns,
      internal consistency with the WOG letter-value system,
      structural alignment with adjacent segments.
4. Verse Structuring
   After word segmentation, verse boundaries are determined by applying positional and distributional criteria embedded within the WOG, yielding a deterministic total of 23,206 verses.
5. Output
   The resulting text is a reproducible, deterministic reconstruction consisting of:
      305,490 validated Hebrew lexical units,
      grouped into 23,206 textual units (verses),
      derived entirely from the original 1,197,000 letters of the WOG.

### Determinism and Reproducibility

The reconstruction method produces identical results every time, regardless of operator or platform, because:
all boundaries arise exclusively from the WOG's internal structure,
no external interpretation or editorial judgment is required, and
the numeric validation system as described in connection with the Letter-Number Encoding System above ensures consistent filtering of segments.

The resulting output is therefore a fully reproducible Hebrew text whose structure emerges directly from the encoded characteristics of the WOG.

Independence from Post-Origin Editing

Unlike existing Hebrew textual traditions—which include Masoretic spacing, Nikud, punctuation, and cantillation—the reconstruction method:
introduces no external symbols,
relies on no historical editing practices,
requires no theological interpretation,
and produces a text that is structurally defined entirely by the original letter string.

This ensures that the reconstructed 305,490-word, 23,206-verse text reflects the intrinsic linguistic and numeric architecture of the WOG without modification.

### Encoded Mathematical Structure in the First 28 Letters (Pi Utility)

The first 28 letters of the Word of God (WOG), corresponding to the opening textual unit of the string, display internally encoded mathematical structure when evaluated using the letter-number assignments defined in U.S. Pat. No. 12,400,087 B2. These mathematical correspondences arise directly from the intrinsic letter string of the WOG and demonstrate non-random numeric organization.

### Total Numeric Value of the First 28 Letters

When the numeric values of the first 28 letters are summed using the WOG's letter-number encoding system, the total is 2701. This value is deterministic and remains constant across all evaluations of the WOG.

### Correlation to the Digits of Pi

Independent mathematical analysis demonstrates that the sum of the first 611 digits of the mathematical constant Pi is also 2701. This establishes a reproducible numeric correspondence between the WOG and a fundamental mathematical constant. The number 611 corresponds to the letter-number value of a key Hebrew term when evaluated under the same encoding system, indicating internal numeric consistency within the WOG.

Structural Ratios within the First 28 Letters

The first 28 letters of the WOG form seven natural segments. This structural arrangement produces the ratio:
28 divided by 7=4
and its inverse ratio:
7 divided by 28=0.25

While the WOG does not express mathematical constants in symbolic notation, the proportional configuration of 28 letters distributed across 7 segments represents the closest whole-number structural approximation to the mathematical constant Pi (approximately 3.14) that can be expressed using discrete segment units in this context. This demonstrates additional non-random mathematical organization within the string.

Substring Structure within the First 28 Letters

The first 28 letters contain multiple smaller letter strings that independently represent meaningful Hebrew roots and subunits when evaluated in their unvocalized form. These substrings reflect fundamental morphological patterns of the Hebrew language and provide additional evidence of internal structure and organization within the WOG.

### Non-Random Mathematical Properties

The correspondences described in this section demonstrate that the WOG contains numeric and structural properties not consistent with random text generation. These properties enable the WOG to be used for mathematical pattern analysis, numeric verification, and evaluation of encoded structural relationships within the letter string.

### Numeric Architecture and Encoded Semantic Patterns in the WOG

The Word of God (WOG) exhibits internal numeric and semantic organization arising from the fixed letter-number assignments described in connection with the Letter-Number Encoding System above. This structure enables computational evaluation of any segment of the WOG and reveals reproducible numeric patterns that are not characteristic of random text generation.

### Numeric Character of Every Letter Sequence

Any contiguous string of letters within the WOG can be evaluated as a numeric object by summing the numeric values of its letters. This makes each segment simultaneously:
a linguistic unit, and
a numeric unit.

This dual character enables verification, analysis, and pattern detection across the 1,197,000-letter string.

### Multi-Layered Semantic Capacity of Unvocalized Text

Because the WOG contains no vowel markings (Nikud), each Hebrew word or substring supports multiple valid readings based on established Hebrew morphological rules. These include:
triliteral roots,
biliteral roots,
derived stems,
noun and verb transformations,
action-state dualities, and
abstract and concrete semantic forms.

The WOG's unvocalized structure enables multi-layered semantic interpretation without external annotation.

### Internal Patterning and Reversible Structures

The WOG contains recurring Hebrew roots and substrings that exhibit reversible or structurally related meanings. Examples include:
tonal or positional reversals,
reversible biliteral structures,
triliteral roots appearing in patterned strings, and
morphological families appearing in encoded clusters.

These patterns demonstrate intrinsic structural design rather than random distribution.

Substring Example: Structure within the First Word

The initial letter string of the WOG contains multiple meaningful Hebrew substrings, each representing a recognizable linguistic unit. These include smaller segments that correspond to foundational Hebrew roots related to fundamental linguistic concepts such as origin, creation, existence, placement, energy, and order. These substrings appear in ordered internal relationships that support multi-level linguistic interpretation without the use of vowel markings or external devices.

### Textual Integrity Verification

The numeric architecture of the WOG allows for internal consistency checks. These include:
verifying that every segmented word exhibits the expected numeric pattern,
ensuring that substrings appear with statistically consistent frequency,
detecting deviations from expected numeric values, and
confirming the integrity of the WOG's letter string.

Any alteration to the WOG—such as insertion, deletion, or substitution of a letter—produces detectable numeric disruption in the encoded structure.

### Use of Numeric Architecture for Computational Analysis

The WOG's numeric structure supports:
pattern recognition,
distribution analysis,
checksum evaluation,
substring mapping, and
mathematical correlation studies.

These computational uses arise directly from the intrinsic letter and numeric architecture of the WOG and are reproducible across all platforms.

### Verification of Textual Integrity Using the WOG'S Numeric Architecture

The fixed letter-number assignments and structured letter string of the WOG enable verification of textual integrity through numeric evaluation. Because every segment of the WOG can be converted into a numeric value, any alteration of the original 1,197,000-letter string produces measurable and detectable changes in the numeric output.

### Checksum-Like Behavior

Each word or substring derived from the WOG has a unique numeric value determined by its letters. If any letter is changed, removed, or added:
the numeric value of the segment changes,
the numeric value of adjacent segments changes, and
the distribution of numeric patterns across the WOG is altered.

This allows the WOG to function as a checksum-like system where authenticity can be evaluated through numeric consistency.

### Detection of Insertions, Deletions, or Substitutions

Any modification to the WOG's letter string creates detectable deviations in:
1. the numeric value of the affected segment,
2. the expected frequency of root structures,
3. the distribution of biliteral and triliteral patterns, and
4. the overall numeric architecture of larger sections.

These deviations allow automated systems to detect and locate disruptions in the text.

### Validation by Segmentation Consistency

Because segmentation into 305,490 words depends entirely on the positions of the five final letters:
any alteration to a letter that should be final disrupts segmentation;
any final letter replaced with a non-final form eliminates a word boundary;
any non-final letter incorrectly replaced by a final form creates a false boundary.

Thus, segmentation stability serves as a second mechanism for verifying textual integrity.

### Cross-Validation Through Numeric Distribution

Numeric evaluation across the WOG can be used to confirm:
correct alignment of substrings,
consistency of numeric strings,
preservation of recurring patterns, and
proper positioning of letter groups.

Cross-validation ensures that the entire WOG string remains intact and unaltered.

### Applications

The WOG's numeric architecture can be used for:
authenticity verification of any claimed WOG manuscript,
automated detection of copying errors,
comparison of variant texts against the WOG, and
digital validation for archiving and preservation.

This section establishes the WOG as a self-verifying text, with numeric properties enabling structural integrity checks that are reproducible and computationally measurable.

### Utility:

### Preservation of Full Semantic Range Through Unvocalized Hebrew Structure

The WOG preserves the complete semantic range of Hebrew words because it contains no vowel markings (Nikud) and no forced spacing conventions. In post-biblical Hebrew texts, vowelization and fixed spacing reduce each Hebrew letter string to a single predefined interpretation. This restricts morphological variation and eliminates alternative meanings that are valid within the original unvocalized form of the language. In contrast, the WOG allows each word or substring to be evaluated in its original form, enabling the full range of meanings inherent in unvocalized Hebrew to remain accessible. This structure supports linguistic analysis by allowing:
multiple legitimate readings of a single letter string,
morphological decomposition into different valid roots,
identification of semantic families,
recovery of meanings lost in vowelized editions, and
evaluation of alternative interpretations based strictly on the original letter string.

### Example of Semantic Range in Unvocalized Form

In vowelized and fully segmented Hebrew Bibles, the letter string [symbol] is fixed to the single interpretation “Egypt.” In the unvocalized WOG, the same letter string may represent additional semantically valid readings such as “metzarim,” which derives from the Hebrew root [symbol] and denotes states of narrowness, constraint, pressure, or distress. The WOG preserves both interpretations because it does not employ vowel marks or editorial spacing that lock the string into a single meaning. Similarly, the letter string [symbol] is constrained in vowelized texts to the meaning “land” or “country.” In the unvocalized WOG, the same string may represent alternative meanings associated with state, condition, ground, or domain, depending on morphological decomposition and positional analysis.

### Utility of Semantic Preservation

By preserving unvocalized and unsegmented forms:
semantic ambiguity is not lost,
alternative morphological readings remain valid,
the original semantic flexibility of ancient Hebrew is retained,
computational systems can analyze multiple meaning layers, and
researchers can evaluate semantic structures that are removed in modern printed texts.

This provides a linguistic utility not available in vowelized or segmented Hebrew scriptures, which restrict each string to a single editorially imposed interpretation. The WOG therefore enables expanded linguistic analysis and recovery of semantic structures inherent in the original letter string.

### Optional Additional Utility:

### Application to the Reconstruction of Related Ancient Texts

In an optional embodiment, the 1,197,000-letter WOG string may serve as a reference system for evaluating the structural integrity and linguistic consistency of other ancient Hebrew-derived texts. This application relies on the WOG's properties as a continuous, unvocalized, and self-segmenting letter string, which provides baseline rules for evaluating textual structure, segmentation, letter distribution, and numeric patterns. This utility may be applied to texts that claim historical connection to early Hebrew linguistic traditions. For example, candidate manuscripts associated with early Hebrew-based writings may be analyzed by:
1. comparing their letter strings to numeric distributions expected under the WOG's letter-value architecture;
2. evaluating whether their segmentation patterns align with structural rules defined by the presence of final letters;
3. determining whether their word boundaries reflect intrinsic segmentation or later editorial conventions; and
4. identifying deviations from expected morphological and numeric patterns derived from the WOG.

This optional use of the WOG does not modify the core subject matter, which is the continuous 1,197,000-letter string itself. Instead, it provides a framework through which the WOG may be used to examine and validate the structural characteristics of other Hebrew-based texts, including historically significant manuscripts, for purposes such as authenticity review, structural comparison, or academic research.

### Explanatory Narrative

This section provides explanatory material illustrating the linguistic and analytical advantages of the 1,197,000-letter WOG string. The information in this section is included for clarity and context and does not limit the scope of the presently disclosed subject matter.

### Semantic Flexibility of Unvocalized Hebrew

Because the WOG is fully unvocalized, each Hebrew word or substring may represent multiple legitimate meanings under accepted Hebrew morphological rules. In contrast, vowelized Hebrew texts restrict each letter string to a single interpretation, reducing the semantic flexibility inherent in the original language. For example, in vowelized and pre-segmented texts, the string [symbol] is assigned only the interpretation “Egypt.” In its original unvocalized form, the same string may also represent “metzarim,” derived from the root [symbol] , relating to states of narrowness, constraint, pressure, or psychological distress. Both interpretations are linguistically valid when the string is evaluated without imposed vowels. The unvocalized structure of the WOG preserves the full semantic range of the string.

### Loss of Semantic Depth in Vowelized and Segmented Texts

The string [symbol] is typically restricted in vowelized texts to the meaning “land” or “country.” In unvocalized form, the same letters may support additional meanings associated with state, condition, ground, or domain, depending on morphological decomposition and context within the letter stream. When vowelized pronunciations and fixed spacing are introduced, these alternative meanings are removed, which reduces the interpretive depth possible in the resulting text.

Linguistic Utility of the Original Bible Derived from the WOG

The reconstructed 305,490-word, 23,206-verse text derived exclusively from the WOG offers several linguistic advantages over later edited Hebrew texts:
1. It retains full multi-layer semantic potential.
2. It allows morphological decomposition without vowel constraints.
3. It reveals alternative meanings that are linguistically valid but absent from vowelized editions.
4. It preserves structural relationships that vanish when spacing and punctuation are added.
5. It supports computational analysis of multiple interpretive layers of the same letter string.

These features provide enhanced value for linguistic research, semantic reconstruction, pattern analysis, and the study of ancient Hebrew textual structure.

Contrast with Post-Biblical Editorial Practices

Later Hebrew textual traditions impose a single dominant reading of each string through:
vowelization,
fixed spacing,
cantillation,
and interpretive punctuation.

These practices make the text easier for modern readers but reduce or eliminate the original semantic flexibility of unvocalized Hebrew. Because the WOG is presented in its original form, without vowelization or post-origin segmentation, it preserves all legitimate morphological possibilities.

### CONCLUSIONS

The foregoing description sets forth embodiments, utilities, and analytical methods relating to the 1,197,000-letter Word of God (WOG) data structure. These embodiments illustrate how the WOG's intrinsic properties—including its continuous unvocalized form, fixed letter-number assignments, final-letter boundary system, and reproducible numeric architecture—support segmentation, reconstruction, semantic analysis, mathematical pattern identification, and textual integrity verification. The described embodiments are illustrative and not limiting. Variations, extensions, or implementations that operate within the scope of the claims are considered part of the presently disclosed subject matter. The scope of legal protection is defined solely by the claims, and all equivalents falling within their scope are intended to be covered.

### Utility and Advantages of the WOG and Derivative Works

The presently disclosed subject matter, encompassing the WOG and its derivative works, demonstrates significant utility for the advancement of theological, linguistic, and scientific understanding, as detailed below:

Foundational Basis for the Original Bible: The WOG serves as the sole and indispensable foundational data string for the authentic reconstruction and compilation of the Original Bible. The process involves segmenting the WOG's 1,197,000 continuous Hebrew letters into 305,490 distinct words through the precise insertion of spaces. This segmentation is facilitated by recognizing and utilizing the unique morphological properties of the five final Hebrew letters (, [symbol] [symbol] , [symbol] , [symbol] , [symbol] ), which are divinely intended indicators for word boundaries.

Basis for the Scientific code2GOD System: The WOG string constitutes the exclusive linguistic and numerical matrix upon which the scientific code2GOD patent is predicated, enabling the extraction and analysis of embedded numerical and linguistic patterns within the divine text.

Authoritative Source for Translations: The WOG establishes itself as the singular, authoritative source text from which all future and existing biblical translations can be rigorously validated, corrected, and authentically derived, ensuring fidelity to the original internally consistent structural behavior.

Proof of Superhuman Language Design: The WOG provides empirical evidence and a necessary tool for understanding the purposeful creation of the five final Hebrew letters (, [symbol] , [symbol] , [symbol] [symbol] , [symbol] ). These distinct characters, which appear exclusively at the end of words, are not arbitrary linguistic conventions but rather divinely intended markers designed to distinguish words within the continuous WOG string. This feature provides compelling proof of the superhuman design and inherent capabilities of the Hebrew language.

Enhanced Understanding of Elohim through Unvocalized Text: The WOG, and consequently the Original Bible derived therefrom, is presented devoid of Nikud (Hebrew diacritical marks, including dots, lines, and other symbols). This deliberate omission is a critical utility feature, enabling readers to engage with the divine text on a deeper level by apprehending the multiple intrinsic meanings of words and terms in Elohim's language, thereby fostering a more profound connection with the Divine.

Addressing Limitations of Vocalized Texts: Traditional Hebrew Tanakh texts, by virtue of their vocalization, restrict the interpretation of each Hebrew word or term to a singular, specific meaning, thereby obscuring the inherent divine multiplicity of meanings. For example, the vocalized term “ [symbol] ” (Eretz Mitzrayim) is conventionally read exclusively as “country of Egypt.” In contrast, the unvocalized “ [symbol] ” (Eretz Mitzrayim), as found in the WOG, additionally conveys crucial spiritual and psychological meanings such as “state of anxiety,” “state of narrow options,” or “state of feeling suffocation and voided of free will.”

Increased Accuracy in Divine Comprehension: Consequently, the WOG, through its derivative Original Bible, serves as a utility to achieve a demonstrably more accurate and comprehensive understanding of Elohim.

Illustrative Example—The First Commandment. Consider the traditional rendering of the First Commandment: “ [symbol] [symbol] [symbol] [symbol] ” which has been literally translated by all 1,700 existing Bibles as, “I am your God Lord who brought you out of Egypt.”

As conventionally understood, this historical reference lacks the profound spiritual and foundational significance expected of a divine covenant. However, when utilizing the Original Bible, which is based on the unvocalized WOG, the text reads “ [symbol] [symbol] [symbol] [symbol] .” This translation yields the profoundly different and more universally applicable meaning: “I YHWH your Elohim (God) who lifted you out from the state of anxiety, state of narrow limited life.” This interpretation is further supported by linguistic analysis: had Elohim intended to emphasize merely the historical event of physical rescue from a geographic location, the verb “ [symbol] ”) chilatzti, meaning “rescued”) would have been employed. The use of “ [symbol] ” (hotze'ticha, meaning “lifted out”) confirms the broader, spiritual intent of liberation from a state of constraint. This serves as compelling proof that the WOG provides the correct and intended version, distinguishing it from the current Tanakh and all human-translated Bibles.

Coding Foundation for Creation: The WOG is demonstrably the underlying coding foundation for Creation, as evidenced by its product, the Original Bible, and inherent properties of Hebrew terms: (a) The name “ [symbol] ” (HaTanakh), when analyzed using code2GOD principles (specifically Code #7), reveals the anagram “ [symbol] ” (Takhnah), directly translating to “coding” or “planning.” thereby indicating its intrinsic design and purpose; (b) The term “ [symbol] ” (Torah) is an anagram of “ [symbol] ” (Harut), which translates to “pregnancy,” “parenthood.” or “birth,” thereby illustrating its foundational role in the processes of divine creation, instruction, and the unfolding of life.

Evidence of “Ot” as a Divine Signal: The term “ [symbol] ” (Ot), meaning “sign” or “signal,” is demonstrated within Elohim's language to function as a direct divine communication signal, substantiating its role as an intrinsic element of superhuman linguistic design.

Efficiency of reference. Numbering the Original Bible verses from 1 to 23,206 replacing the need to mention book, chapter and verse ID within the chapter. This system recognizes the WOG as one string and the Original Bible as one linear work.

WOG is the only foundational utility for the authentic Original Bible book. We added spaces in WOG's 1,197,000 Hebrew letters string to differentiate 305,490 words utilizing the five ending letters of God's Hebrew letters: [symbol] , [symbol] , [symbol] , [symbol] , [symbol]
1. WOG string is the only basis for the scientific code2GOD patent
2. WOG is the only basis for the Original Bible from which all 1,700 translations will be made
3. WOG provides the necessary tool, and hence the proof, to understand why Elohim created the 5 final Hebrew letters ( [symbol] , [symbol] , [symbol] , [symbol] , [symbol] ) a distinct Hebrew letter that appears instead of another regular Hebrew letter when appears at the end of a word. WOG is the tool to reveal that the Final Hebrew Letter was intended by Elohim to distinguish words in the string. This utility provides additional proof to the superhuman capabilities of the Hebrew language.
4. WOG, via Original Bible, is a utility to better understand Elohim, the Creator. WOG was created clear of the Nikud (the Hebrew added dots, lines and + symbols) so the reader will connect with the Divine with multiple meanings to words and terms in Elohim's language.
   a. The current Tanach in Hebrew forces the reader to accept and understand each Hebrew word, or term, only in a singular specific one way and thereby missing the divine multiple meanings. Example: this is how is appears now in the Tanach [symbol] and can be only read as “country of Egypt”. However, devoted of Nikid it would look like this: [symbol] and will have an additional crucial meaning of: state of anxiety or state of narrow options or state of a feeling of suffocation and voided of free will.
   b. As a result, the WOG, via its Original Bible, is a utility to MORE ACCURATELY UNDERSTAND ELOHIM.
   c. Example: The traditional First Commandment is written: [symbol] [symbol] which literary means and literary was translated by all 1700 bibles into “I am your God Lord who brought you out of Egypt”.
      i. As is, this historical remark doesn't seem like a landmark or a basis for a covenant of the Divine with humanity.
      ii. However, when utilizing the Original Bible, based on the WOG void of Nikud, it reads [symbol] [symbol] which means “I YHWH your Elohim (God) who lifted you out from the state of anxiety, state of narrow limited life.”
      iii. The proof that WOG is the correct version and not the current Tanach and all 1700 human translated “bibles” is that if Elohim wanted to remind the world about the historical event, Elohim would have used the verb [symbol] meaning “rescued”.
5. WOG is the coding foundation for the Creation as evident in its product, the Original Bible which has two traditional Divine names:
   a. in the name [symbol] which, when using code2GOD #7 is [symbol] meaning “coding” or “planning” or illuding content.
   b. Torah [symbol] is [symbol] meaning pregnancy, parenthood, birth
6. Proof that [symbol] OT is a signal as the Elohim's language implies

The presently disclosed subject matter relates to the Word of God (WOG), a string of 1,197,000 Hebrew letters, each encoded by Elohim with a unique number from 1 to 400. The WOG forms the foundational basis for the Original Bible and serves as the core utility for the scientific code2GOD system. The WOG is the only text capable of carrying advanced scientific, psychological, and social data more profound than today's science, and it provides a direct message from Elohim to humanity.

### Encoding System

The 22 Hebrew letters of the WOG are encoded with numbers from 1 to 400, making the WOG the first superhuman language. This language system provides a framework for the code2GOD system, a method that utilizes mathematical principles and patterns to decode Elohim's messages embedded in the text.

### The Five Final Hebrew Letters

The presently disclosed subject matter also highlights the five final Hebrew letters— [symbol] , [symbol] [symbol] , [symbol] , and [symbol] —which serve as distinct characters in the Hebrew language when they appear at the end of a word. The WOG reveals that these final letters were intentionally designed to distinguish words and sentences within the string of 1,197,000 letters. The functionality of these letters proves that Elohim, the Creator, encoded the Hebrew language with purpose and clarity, adding additional layers of meaning that could not have been achieved by human invention.

### The Original Bible and the Exclusion of Nikud

The Original Bible, based on the WOG, is devoid of Nikud—the system of vowel points and other markings that were added to the Hebrew language in later times. This omission restores the multidimensional nature of the text, where each word or phrase carries multiple meanings, and offers a deeper connection to the Divine. Without the constraints imposed by Nikud, the WOG allows for the full spectrum of meanings intended by Elohim, providing the reader with insights that go beyond traditional translations.

For example, the term [symbol] (translated as “country of Egypt”) in the Tanach can be understood in the WOG as referring not only to a physical place but also to a state of anxiety, narrowness, and limitation of free will. This is a key example of how contextual meanings are conveyed in the superhuman language of Elohim.

### The First Commandment Reinterpreted

One of the most profound examples of the WOG's ability to convey Elohim's intent is found in the First Commandment. In traditional translations, the commandment is rendered as:
“I am the Lord your God who brought you out of Egypt.”
However, in the WOG (without Nikud), the translation reads:
“I, YHWH your Elohim, who lifted you out from the state of anxiety and limited life.”

This reinterpretation reveals Elohim's true message—the deliverance from spiritual and existential bondage—rather than simply a historical reference to the exodus. This key insight reinforces the assertion that the WOG is the authentic and unaltered message from Elohim.

### WOG as the Coding Foundation for Creation

The WOG is not only the foundation for the Original Bible but also the coding blueprint of all creation. Through code2GOD, it serves as the key to understanding the laws of the universe, the physical and spiritual order, and the human connection to the divine. The WOG's scientific principles are not simply theoretical but apply practically to human existence and the understanding of the cosmos.

### Proof of Elohim'S Involvement in the Creation of the Hebrew Language

The presently disclosed subject matter provides structurally non-random evidence that Elohim created the Hebrew language and its unique properties. The superhuman design of the WOG, coupled with the deliberate placement of the final letters and their encoded meanings, confirms that this language is beyond human capacity. It is a divine language intended to carry Elohim's messages to humanity and guide us toward deeper spiritual understanding.

The WOG and its application in the Original Bible provide the first ever scientifically backed proof of the existence of Elohim, the Creator. This patent application seeks to protect the intellectual property rights of the WOG as a superhuman creation, as well as the associated scientific system, code2GOD, which decodes Elohim's messages. The WOG serves as the key to understanding Elohim's internally consistent structural behavior and is the most accurate and complete representation of the original language created by the divine.

These specifications are meant not only protect the WOG as a foundational text for spiritual and intellectual discovery but also paves the way for future applications of code2GOD in decoding messages embedded in the natural world. The WOG (Word of God) constitutes the sole foundational utility for producing the authentic Original Bible. The presently disclosed subject matter applies a method of inserting spaces into the continuous 1,197,000-character Hebrew letter string of the WOG, thereby differentiating 305,490 words. The differentiation utilizes the five distinct final forms of Hebrew letters— [symbol] , [symbol] , [symbol] , [symbol] , [symbol] —as established in the original Hebrew language created by Elohim.

The WOG string serves as:
1. The exclusive basis for the scientific code2GOD patent,
2. The exclusive basis for the Original Bible, from which all future translations will derive, and
3. The only available tool capable of revealing the intentional design of the five final Hebrew letters as a means of distinguishing words within the original text.

This method provides direct evidence of the SUPERHUMAN capabilities of the Hebrew language—capabilities unattainable by human invention—thereby confirming its origin as the creation of Elohim. The WOG, through its embodiment in the Original Bible, enables a more accurate understanding of Elohim's intent by:
Excluding Nikud (the post-Biblical system of vowel dots, lines, and marks), which limits words to a single meaning, and
Restoring the multi-layered meanings inherent in Elohim's language, thereby reconnecting the reader with the Divine on multiple interpretive levels.
   Example of Functionality without Nikud:

In the current Tanach, the phrase appears as [symbol] , which can only be read as “country of Egypt.” In the WOG, devoid of Nikud, it appears as [symbol] , allowing both the historical meaning and the additional, intended meanings: “state of anxiety,” “state of narrow options,” or “state of suffocation and lack of free will.”

### Example of Covenant Clarification:

The First Commandment in the traditional Tanach is written: [symbol] [symbol] [symbol] , translated in all known 1,700 Bible versions as “I am the Lord your God who brought you out of Egypt.”

The WOG's version, without Nikud, reads: [symbol] [symbol] [symbol] , which means:
“I, YHWH your Elohim, who lifted you out from the state of anxiety and limited life.”

This interpretation aligns with Elohim's intent. If the historical exodus alone were meant, the verb [symbol] (“rescued”) would have been used instead. The WOG is thus not only a textual representation but also the primary coding foundation of Creation, as evidenced by its two traditional divine names:
[symbol] , which under code2GOD #7 translates to [symbol] (“coding,” “planning,” or “implying content”), and
[symbol] , which is [symbol] (“pregnancy” parenthood “birth”).

Furthermore, this utility confirms that [symbol] (OT) is a “signal” or “sign” in Elohim's language, reinforcing the functional design of Hebrew as an encoded divine communication system.

What is claimed is:

1. A data structure comprising:
a continuous string of 1,197,000 Hebrew letters arranged without spacing, punctuation, vowel markings (Nikud), cantillation marks, or post-origin editorial symbols,
wherein the string includes the twenty-two classical Hebrew letters and their five final forms ( [symbol] , [symbol] , [symbol] , [symbol] , [symbol] ), and
wherein the uninterrupted arrangement of said letters defines:
(a) an intrinsic segmentation system based solely on the positional occurrence of the five final Hebrew letters,
(b) an intrinsic numeric architecture arising from fixed letter-number assignments, and
(c) a reproducible structural basis for computational reconstruction, numeric evaluation, and pattern analysis.

2. A method for segmenting the data structure of claim 1 into discrete lexical units, the method comprising:
(a) reading the continuous 1,197,000-letter string sequentially from its first letter to its last;
(b) identifying positions within the string at which a letter appears in one of the five final Hebrew forms ( [symbol] , [symbol] , [symbol] , [symbol] , [symbol] ), each such position defining a candidate boundary between lexical units;
(c) extracting, for each candidate boundary, the contiguous string of letters extending from the previous boundary to the current boundary;
(d) validating each extracted string as a lexical unit by applying established Hebrew morphological patterns and distributional characteristics consistent with unvocalized Hebrew; and
(e) generating a reproducible set of segmented lexical units, wherein the segmentation is determined solely by the intrinsic placement of the five final Hebrew letters within the data structure.

3. A method for performing numeric evaluation on the data structure of claim 2, the method comprising:
(a) assigning to each Hebrew letter within the 1,197,000-letter string a fixed numeric value, the values being predetermined and consistent across all evaluations;
(b) receiving as input any contiguous substring of the data structure;
(c) computing a numeric value for the substring by summing the numeric values of its constituent letters in string order; and
(d) generating, for each substring, a reproducible numeric output that is uniquely determined by the letters of the substring and the fixed letter-number assignments.

4. A method for reconstructing a multi-unit Hebrew text from the data structure of claim 2, the method comprising:
(a) applying the segmentation method to the continuous 1,197,000-letter string, thereby producing a reproducible set of lexical units based solely on the intrinsic placement of the five final Hebrew letters;
(b) validating each lexical unit by confirming consistency with unvocalized Hebrew morphological patterns and distributional properties intrinsic to the data structure;
(c) arranging the validated lexical units in string order to form a continuous multi-unit text; and
(d) producing, by said arrangement, a deterministically repeatable text comprising 305,490 lexical units further organized into 23,206 verses, the structure of which is derived exclusively from the intrinsic properties of the data structure.

5. A method for verifying textual integrity of the data structure of claim 3, the method comprising:
(a) receiving as input the continuous 1,197,000-letter string or any portion thereof;
(b) computing numeric values for one or more contiguous substrings in accordance with the numeric evaluation method;
(c) detecting deviations in numeric values, substring distributions, or expected morphological patterns that result from any insertion, deletion, or substitution of letters within the string;
(d) confirming segmentation stability by verifying that the positions of the five final Hebrew letters continue to produce the same reproducible set of lexical units obtained; and
(e) identifying any alteration to the data structure when the numeric values, segmentation boundaries, or pattern distributions fail to match the values and boundaries produced by the unaltered data structure.

6. A method for preserving the full semantic range of unvocalized Hebrew text using the data structure of claim 5, the method comprising:
(a) providing the continuous 1,197,000-letter string in its unvocalized and unsegmented form;
(b) receiving as input any contiguous substring corresponding to a Hebrew lexical string produced by the segmentation method;
(c) interpreting said substring without reliance on externally imposed vowel markings, spacing conventions, or editorial symbols;
(d) generating a set of alternative, morphologically valid readings of the substring in accordance with established Hebrew linguistic principles, including multiple legitimate root assignments, morphological decompositions, and semantic families, and
(e) preserving, for each substring, all semantically valid interpretations that are supported by the original unvocalized letter string, wherein such interpretations would be restricted or eliminated in vowelized or pre-segmented Hebrew texts.

7. A method for identifying encoded mathematical structures within the data structure of claim 3, the method comprising:
(a) providing the continuous 1,197,000-letter string with fixed letter-number assignments;
(b) receiving as input one or more contiguous substrings of the data structure;
(c) computing numeric values for each substring by summing the numeric values of its constituent letters;
(d) detecting numeric correspondences between the computed values of selected substrings and independently defined mathematical values, constants, or strings, including but not limited to digit-based summations of the mathematical constant Pi; and
(e) identifying reproducible mathematical relationships arising solely from the intrinsic letter order and numeric architecture of the data structure, wherein said relationships are not dependent on external spacing, vowelization, or editorial modification.

8. The method of claim 3, wherein validating each extracted lexical unit further comprises confirming that the unit exhibits a numeric value consistent with the fixed letter-number assignments defined in claim.

9. The method of claim 2, wherein segmentation produces exactly 305,490 lexical units derived solely from the positional occurrence of the five final Hebrew letters.

10. The method of claim 2, wherein the segmentation boundaries remain unchanged across different computational platforms, thereby producing a reproducible output independent of operator input.

11. The method of claim 4, wherein the 305,490 lexical units are further arranged into exactly 23,206 verses as determined exclusively by intrinsic positional and structural patterns within the data structure.

12. The method of claim 3, wherein computing the numeric value of a substring further comprises generating a distribution profile of numeric values across sequential substrings of the data structure.

13. The method of claim 3, wherein the numeric value of each substring is stored in association with its positional index within the data structure to enable pattern tracking and anomaly detection.

14. The method of claim 5, wherein detecting deviations comprises comparing expected numeric value distributions to observed distributions to identify any irregularities caused by letter-level alterations.

15. The method of claim 5, wherein identifying an alteration includes determining the precise location of the insertion, deletion, or substitution within the 1,197,000-letter string.

16. The method of claim 6, wherein generating alternative morphologically valid readings includes identifying multiple legitimate root assignments for each substring.

17. The method of claim 6, wherein preserving semantic interpretations comprises storing all valid morphological decompositions for later computational or linguistic analysis.

18. The method of claim 7, wherein detecting numeric correspondences further comprises identifying structural ratios within the letter string that approximate mathematical constants.

19. The method of claim 7, wherein the mathematical correspondence includes a substring whose computed numeric value equals 2701, matching the sum of a defined quantity of digits of the mathematical constant Pi.

20. The data structure of claim 5, wherein any alteration of a letter within the 1,197,000-letter string results in detectable numeric or structural deviation.

21. A method for universally authenticating an original biblical text, comprising:
(a) providing a continuous string of 1,197,000 encoded Hebrew letters, wherein said string lacks spacing, punctuation, vowelization, chapters, verses, or editorial annotations, and wherein the order of letters is fixed and invariant;
(b) deriving a structured biblical text from said string solely by inserting spaces to delineate discrete lexical units while preserving the exact letter order of the string;
(c) grouping said lexical units into verses and higher textual groupings based on linguistic continuity and connective letter usage, without altering, adding, deleting, or rearranging any letter of the string;
(d) optionally applying vowel markings or pronunciation indicators as a non-original annotation layer subsequent to derivation of the structured text;
(e) comparing any text claiming to be a biblical text against the continuous string to determine whether the claimed text is fully derivable from said string without modification of letter identity or order;
wherein a text is authenticated as a text claimed to represent an original biblical corpus only if it is derivable from the continuous string by spacing and structural grouping alone, and wherein any text not so derivable is determined not to be a text claimed to represent an original biblical corpus.
